(19) United States
(12) Patent Application Publication
(10) Pub. No.: US 2023/0152539 A1
(43) Pub. Date: May 18, 2023

(54) OPTICAL WAVEGUIDE ELEMENT, AND OPTICAL MODULATION DEVICE AND OPTICAL TRANSMISSION DEVICE USING SAME

(71) Applicant: SUMITOMO OSAKA CEMENT CO., LTD., Tokyo (JP)

(72) Inventors: Yuki KUGIMOTO, Tokyo (JP); Norikazu MIYAZAKI, Tokyo (JP); Yu KATAOKA, Tokyo (JP)

(73) Assignee: SUMITOMO OSAKA CEMENT CO., LTD., Tokyo (JP)

(21) Appl. No.: 17/916,505

(22) PCT Filed: Dec. 18, 2020
(86) PCT No.: PCT/JP2020/047465

§ 371 Date: Sep. 30, 2022

(30) Foreign Application Priority Data
Mar. 31, 2020 (JP) 2020-063336

(51) Int. Cl. G02B 6/42

(52) U.S. Cl. CPC G02B 6/4257; G02B 6/4239

(57) ABSTRACT

To provide an optical waveguide device in which damage to a thin plate, particularly damage to an optical waveguide, is prevented. An optical waveguide device includes: a thin plate 1 that has an electro-optic effect and that has a thickness of equal to or thinner than 10 μm, an optical waveguide 2 being formed on the thin plate; and a reinforcing substrate that supports the thin plate, in which the thin plate 1 has a rectangular shape in a plan view, a dissimilar element layer 3, in which an element different from an element constituting the thin plate is disposed in the thin plate, is formed on at least a portion between an outer periphery of the thin plate and the optical waveguide 2, and a total length over which a cleavage plane of the thin plate traverses a region where the dissimilar element layer is formed, is equal to or longer than 5% of a width of the thin plate in a short side direction.

### TECHNICAL FIELD

The present invention relates to an optical waveguide device, an optical modulation device using the same, and an optical transmission apparatus, and more particularly relates to an optical waveguide device including: a thin plate that has an electro-optic effect and that has a thickness of equal to or thinner than 10 μm, an optical waveguide being formed on the thin plate; and a reinforcing substrate that supports the thin plate.

### BACKGROUND ART

In the fields of optical measurement technology and optical communication technology, an optical waveguide device such as an optical modulator using a substrate having an electro-optic effect is widely used. Further, in order to widen the frequency response characteristics or in order to reduce the drive voltage, efforts are being made to thinly configure the thickness of a substrate substantially equal to or thinner than 10 μm, reduce an effective refractive index of a microwave that is a modulation signal, achieve the velocity matching between microwaves and light waves, and improve an electric field efficiency.

When the thin plate having a thickness of equal to or thinner than 10 μm is used, the mechanical intensity of the thin plate is weak, and as shown in Patent Literature No. 1, adhesive fixing is performed on the reinforcing substrate that supports the thin plate.

However, the thin plate having a thickness of equal to or thinner than 10 μm loses toughness and becomes very fragile, thereby even when the thin plate is reinforced by a reinforcing substrate, a problem arises that cracks are created only in the thin plate, the optical waveguide is damaged, and the optical loss increases. Particularly, when a chip for each optical waveguide device is cut out from a wafer substrate on which the optical waveguide is formed, a mechanical load is applied to the thin plate, causing a problem that the thin plate is easily damaged.

### CITATION LIST

### Patent Literature

[Patent Literature No. 1] Japanese Laid-open Patent Publication No. 2010-85789

### SUMMARY OF INVENTION

### Technical Problem

The problem to be solved by the present invention is to provide an optical waveguide device, an optical modulation device using the same, and an optical transmission apparatus, in which the problem described above is resolved and damage to a thin plate, particularly damage to an optical waveguide is prevented.

### Solution to Problem

In order to solve the above problems, an optical waveguide device of the present invention has the following technical features.

(1) An optical waveguide device includes: a thin plate that has an electro-optic effect and that has a thickness of equal to or thinner than 10 μm, an optical waveguide being formed on the thin plate; and a reinforcing substrate that supports the thin plate, in which the thin plate has a rectangular shape in a plan view, a dissimilar element layer, in which an element different from an element constituting the thin plate is disposed in the thin plate, is formed on at least a portion between an outer periphery of the thin plate and the optical waveguide, and a total length over which a cleavage plane of the thin plate traverses a region where the dissimilar element layer is formed, is equal to or longer than 5% of a width of the thin plate in a short side direction.

(2) In the optical waveguide device according to (1), a thickness of the dissimilar element layer is equal to or thicker than half of a thickness of the thin plate.

(3) In the optical waveguide device according to (1) or (2), the dissimilar element layer is formed by diffusing titanium.

(4) In the optical waveguide device according to (3), the optical waveguide is a diffused waveguide in which a high refractive index material is diffused, the dissimilar element layer and the optical waveguide are formed on the same surface of the thin plate, and a thickness from a surface of the thin plate to a highest portion of the dissimilar element layer is set to be thicker than a thickness from the surface of the thin plate to a highest portion of the optical waveguide.

(5) In the optical waveguide device according to any one of (1) to (4), an electrode is formed on the thin plate, and the electrode and the dissimilar element layer are formed apart from each other.

(6) An optical modulation device includes: the optical waveguide device according to any one of (1) to (5); a case that accommodates the optical waveguide device; and an optical fiber that inputs a light wave from an outside of the case to the optical waveguide or that outputs the light wave from the optical waveguide to the outside of the case.

(7) In the optical modulation device according to (6), an electronic circuit that amplifies a modulation signal, which is input to the optical waveguide device, is provided inside the case.

(8) An optical transmission apparatus includes: the optical modulation device according to (6) or (7); and an electronic circuit that outputs a modulation signal that causes the optical modulation device to perform a modulation operation.

### Advantageous Effects of Invention

In the present invention, an optical waveguide device includes: a thin plate that has an electro-optic effect and that has a thickness of equal to or thinner than 10 μm, an optical waveguide being formed on the thin plate; and a reinforcing substrate that supports the thin plate, in which the thin plate has a rectangular shape in a plan view, a dissimilar element layer, in which an element different from an element constituting the thin plate is disposed in the thin plate, is formed on at least a portion between an outer periphery of the thin plate and the optical waveguide, and a total length, over which a cleavage plane of the thin plate traverses a region where the dissimilar element layer is formed, is equal to or longer than 5% of a width of the thin plate in a short side direction, thereby even when a crack is created along the cleavage plane of the thin plate from the outer periphery of the thin plate toward the optical waveguide, the progress of the crack is prevented due to the dissimilar element layer, and it is possible to suppress damage to the optical waveguide.

### BRIEF DESCRIPTION OF DRAWINGS

FIG. 1 is a plan view for describing a first example of an optical waveguide device of the present invention.

FIG. 2 is a cross-sectional view taken along the dotted line X-X′ in FIG. 1.

FIG. 3 is a plan view for describing a second example of an optical waveguide device of the present invention.

FIG. 4 is a plan view for describing a third example of an optical waveguide device of the present invention.

FIG. 5 is a plan view for describing a fourth example of an optical waveguide device of the present invention.

FIG. 6 is a plan view for describing a fifth example of an optical waveguide device of the present invention.

FIG. 7 is a view for describing a relationship between a formation region of a dissimilar element layer and a cleavage plane.

FIGS. 8A to 8F are views for describing a relationship of disposition between the optical waveguide and the dissimilar element layer.

FIG. 9 is a view showing an example (Example 1) of a wafer forming the optical waveguide device of the present invention.

FIG. 10 is a view showing an example (Example 2) of a wafer forming the optical waveguide device of the present invention.

FIG. 11 is a view showing an example (Example 3) of a wafer forming the optical waveguide device of the present invention.

FIG. 12 is a view showing an optical modulation device and an optical transmission apparatus of the present invention.

### DESCRIPTION OF EMBODIMENTS

Hereinafter, an optical waveguide device, an optical modulation device using the same, and an optical transmission apparatus of the present invention will be described in detail using preferred examples.

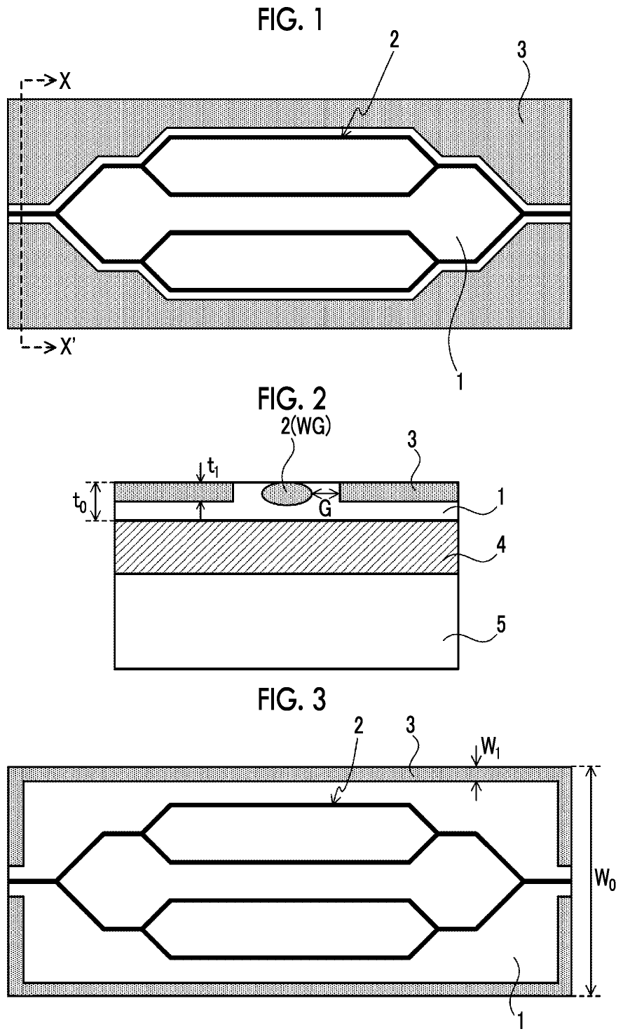

According to the optical waveguide device of the present invention, as shown in FIGS. 1 to 6, the optical waveguide device includes: a thin plate 1 that has an electro-optic effect and that has a thickness of equal to or thinner than 10 μm, an optical waveguide 2 (WG) being formed on the thin plate; and a reinforcing substrate 5 that supports the thin plate, in which the thin plate 1 has a rectangular shape in a plan view, a dissimilar element layer 3, in which an element different from an element constituting the thin plate is disposed in the thin plate, is formed on at least a portion between an outer periphery of the thin plate and the optical waveguide 2, and a total length, over which a cleavage plane of the thin plate traverses a region where the dissimilar element layer is formed, is equal to or longer than 5% of a width of the thin plate in a short side direction.

As the substrate 1 that is used in the optical waveguide device of the present invention, a substrate having an electro-optic effect can be used, such as lithium niobate (LN) or lithium tantalate (LT), lead lanthanum zirconate titanate (PLZT). Particularly, the present invention can be effectively applied to an X-plate LN substrate in which the cleavage plane is formed along the surface of the wafer.

The optical waveguide, which is formed on the substrate 1, can be formed by diffusing Ti or the like on the surface of the substrate by using a thermal diffusion method, a proton exchange method, or the like. Further, it is also possible to use rib-shaped waveguides in which a portion of the substrate corresponding to the optical waveguide is made to a protruding shape, such as by etching a portion of the substrate 1 other than the optical waveguide or forming a groove on both sides of the optical waveguide.

The thickness of the substrate 1 is set to equal to or thinner than 10 μm, more preferably equal to or thinner than 5 μm, in order to achieve velocity matching between the microwave and the light wave of the modulation signal. In order to increase the mechanical intensity of the substrate 1, as shown in FIG. 2, a reinforcing substrate 5 is adhered and fixed to the substrate 1 via an adhesive layer 4 such as resin on a back surface of substrate (thin plate) 1. A material having a coefficient of thermal expansion close to that of the substrate 1, such as the same LN substrate as that of the substrate 1, is used for the reinforcing substrate 5. Furthermore, when the substrate (thin plate) 1 and the reinforcing substrate 5 are directly joined without using the adhesive layer 4, the thickness of the substrate 1 can be set to equal to or thinner than 1 μm, preferably equal to or thinner than 0.7 μm.

The feature of the optical waveguide device of the present invention is that, as shown in FIGS. 1 and 3 to 6, a dissimilar element layer 3, in which an element different from an element constituting the thin plate is disposed in the thin plate, is formed at least a portion between the outer periphery of the thin plate 1 and the optical waveguide 2. As a material constituting the dissimilar element layer, a material such as Ti, MgO, or Zn that can form a dissimilar element layer in the substrate by thermal diffusion can be preferably used.

In the dissimilar element layer 3, a dissimilar element is dissolved in a crystal substrate having an electro-optic effect by thermal diffusion. As a result, a dislocation movement is suppressed and the material is strengthened (solution strengthening). Further, the presence of the dissimilar element layer 3 can suppress the creation of a crack in the thin plate due to the thermal stress and the cutting stress in the manufacturing step. Furthermore, by diffusing the dissimilar element, the cleavage plane of LN or the like is locally disturbed, thereby even when a crack is created, the crack does not extend in the cleavage direction, which can prevent the optical waveguide from being damaged.

FIGS. 1 and 3 to 6 illustrate a formation pattern of the dissimilar element layers when the optical waveguide device is viewed from above. In FIG. 1, the dissimilar element layers 3 are disposed over a wide range from the outer periphery of the thin plate 1 to the optical waveguide 2. In FIG. 3, the dissimilar element layers 3 are disposed around the outer periphery of the thin plate 1 where a crack is likely to be created.

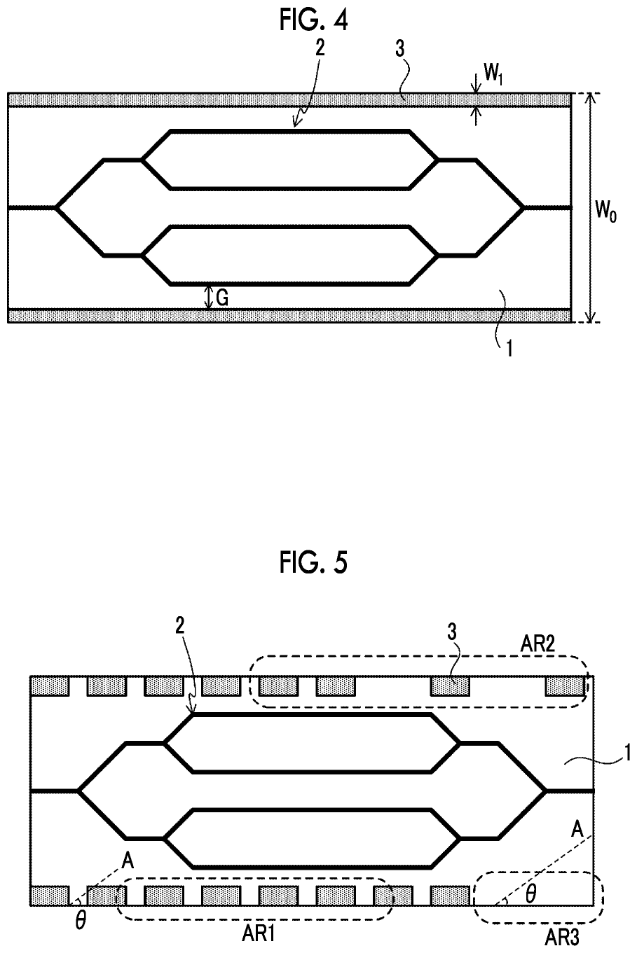

In FIG. 4, the dissimilar element layers 3 are disposed along the long side of the thin plate 1 to suppress, for example, the influence of a crack that is likely to be created when a chip is cut along the long side of the thin plate 1.

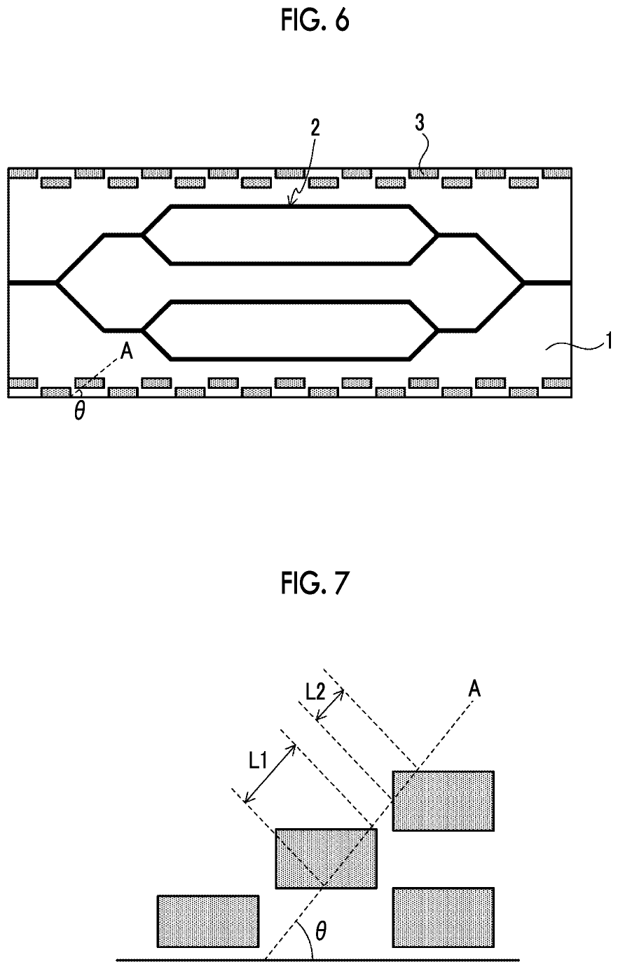

FIGS. 5 and 6 show the dissimilar element layers 3 disposed discretely, and the dissimilar element layers 3 are formed such that a portion of the dissimilar element layer 3 is always present along the direction in which a cleavage plane A generated in the thin plate 1 progresses.

For a disposition pattern of the dissimilar element layers 3, the dissimilar element layers 3 may be disposed in a regular pattern at a constant pitch as shown in a region AR1 in FIG. 5, and the dissimilar element layers 3 may also be disposed in an irregular pattern focusing on places to be particularly protected by the dissimilar element layers 3 as shown in a region AR2. Furthermore, when there is no waveguide in a direction of the cleavage plane A, it is possible to omit the dissimilar element layer as in a region AR3.

The longer the length of the dissimilar element layer 3 along the cleavage plane A of the thin plate 1 is, the more effectively the progress of the crack can be prevented. FIG. 7 illustrates the dissimilar element layers disposed discretely along the cleavage plane A. In the present invention, when a total of the lengths (L1, L2), over which the cleavage plane traverses the dissimilar element layers, is equal to or longer than 5% of a width of the thin plate in a short side direction as will be described later, the progress of the crack along the cleavage plane can be effectively suppressed to some extent.

As shown in FIG. 2, a clearance G between the dissimilar element layer 3 and the optical waveguide 2 may be set to be equal to or longer than a mode field diameter (MFD) of the light wave propagating through the optical waveguide in order to prevent light waves propagating through the optical waveguide from being scattered or absorbed by the presence of the dissimilar element layer.

Further, regarding the thickness of the dissimilar element layer 3, as compared with the thickness of a portion where a cleavage plane is generated in relation to the thickness direction of the thin plate 1 so-called a portion where no dissimilar element layer is formed when the thickness of the dissimilar element layer 3 is equal to or thicker than the thickness of the portion, the creation of the crack in the cleavage plane can be effectively suppressed. Therefore, the thickness t1 of the dissimilar element layer 3 may be set to a thickness equal to or thicker than half of the thickness t0 of the thin plate. It is more preferable to form the dissimilar element layer 3 over the entire thin plate 1 in the thickness direction.

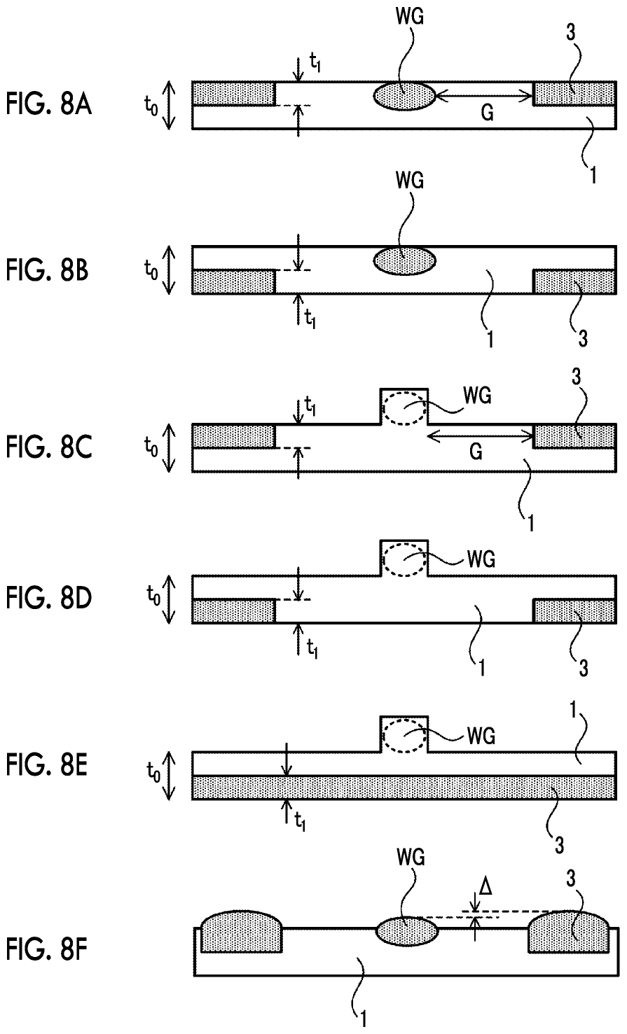

FIGS. 8A to 8F show an example in which the dissimilar element layers 3 are disposed with respect to various optical waveguides WG. In FIG. 8A, as in FIG. 2, the dissimilar element layer 3 is disposed on the same surface as the diffused waveguide WG. In the present configuration, when titanium is used for the dissimilar element layer 3, it is possible to form the dissimilar element layer 3 simultaneously with the thermal diffusion of titanium in the optical waveguide. However, since the mechanical intensity of the dissimilar element layer is set higher than that of the portion in the optical waveguide, the amount of titanium (the amount of titanium disposed per unit area) formed on the surface of the thin plate before the thermal diffusion may be larger in the dissimilar element layer than in the optical waveguide, and the thickness of the dissimilar element layer may be substantially thicker than that in the optical waveguide. As shown in FIG. 8F, in this case, an upper surface of the dissimilar element layer 3 or the optical waveguide WG becomes a protruding shape rising from the surface of the thin plate, and the height of the protruding-shaped portion is higher in the dissimilar element layer than in the optical waveguide by the amount indicated by symbol A. Even in a case where the elements that thermally diffuse are different between the optical waveguide and the dissimilar element layer when the height of the dissimilar element layer is set higher than the height of the optical waveguide, it is possible to more stably suppress a crack from reaching the optical waveguide.

As shown in FIG. 8B, a surface on which the optical waveguide WG is formed and a surface on which the dissimilar element layer 3 is formed can be set on different surfaces (surfaces facing each other) of the thin plate 1. When the thickness of the thin plate is equal to or thinner than 10 μm, particularly equal to or thinner than 5 μm, it becomes easier for the element, which is thermally diffused from one surface, to reach the vicinity of the opposite surface, thereby it is possible to form the dissimilar element layer with higher uniformity. As shown in FIG. 8B, even when the optical waveguide and the dissimilar element layer are formed on different surfaces, a sufficient effect of suppressing a crack can be obtained.

FIGS. 8C and 8D show a case in which a rib type optical waveguide is formed as the optical waveguide WG. In this case, as in FIGS. 8A and 8B, it is also possible to form the dissimilar element layer 3 on the same surface as the optical waveguide WG or on a different surface (surfaces facing each other) from the optical waveguide WG. Furthermore, as shown in FIG. 8E, it is possible to form the dissimilar element layer 3 over the entire back surface of the thin plate 1. In this case, since the region, where the dissimilar element layer 3 is formed, extends over the entire thin plate, the mechanical intensity of the thin plate can be uniformly increased. As for the configuration of the optical waveguide WG, it is also possible to form a diffused waveguide made of Ti or the like to match the protruding portion of the rib type waveguide.

In the optical waveguide device such as an optical modulator, in order to modulate the light wave propagating through the optical waveguide and in order to control a bias point, a control electrode, such as a signal electrode, a ground electrode, or a DC bias electrode, is placed on an upper side or in the vicinity of the optical waveguide. In a case in which such an electrode is provided on the thin plate, when a difference between the coefficient of thermal expansion of the electrode and the thin plate, especially the coefficient of thermal expansion of the dissimilar element layer is large, the electrode peeling in the region where the dissimilar element layer is formed or the internal stress in the region where the dissimilar element layer is formed increases, and in the worst case, the substrate is damaged at a portion of the dissimilar element layer. Therefore, the region where the dissimilar element layer is formed and the region where the electrode is formed may be disposed apart from each other. In the present invention, it is not prohibited to form an electrode on the dissimilar element layer as long as the electrode peeling or damage to the substrate as described above does not occur.

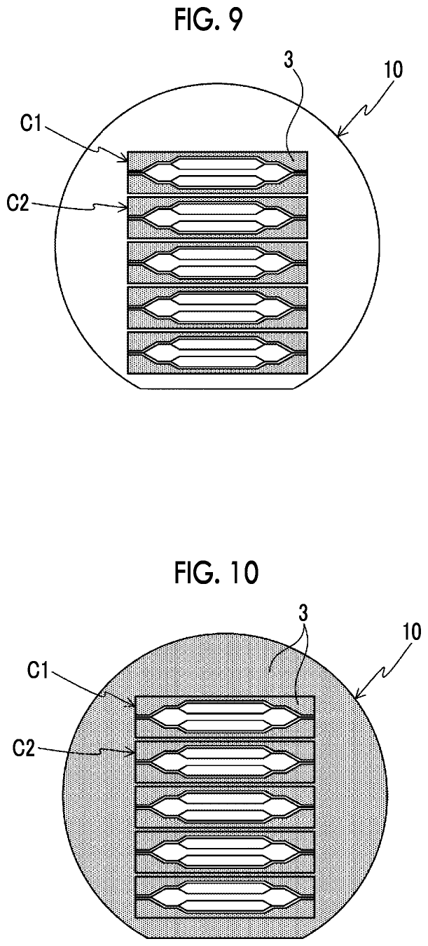

FIGS. 9 to 11 show a pattern of regions where the dissimilar element layers are formed in a wafer state. The wafer 10 may be in any state before or after being processed into a thin plate. In order to prevent the wafer from being damaged due to the thermal stress during the thermal diffusion, the optical waveguide or the dissimilar element layer may be formed before processing the wafer into a thin plate.

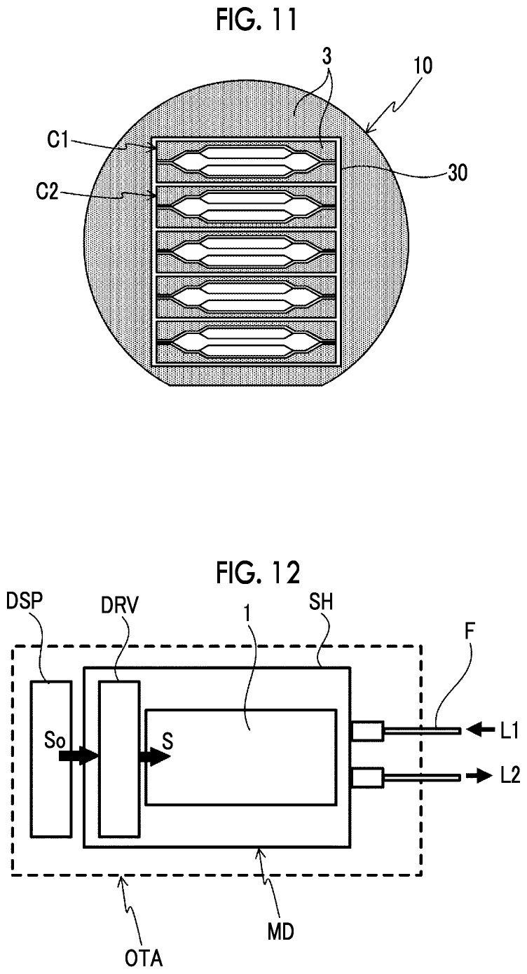

In FIG. 9, the dissimilar element layers 3 are formed only on chip portions (C1, C2) constituting the optical waveguide device, thereby suppressing a crack, which is created from a peripheral portion of the wafer 10, from progressing inside the chip portions. In FIG. 10, the dissimilar element layers are spread over the entire wafer, thereby suppressing the creation and progression of a crack over the entire wafer. Furthermore, in FIG. 11, in order to facilitate the final cutting out of the chip portions (C1, C2) constituting the optical waveguide device from the wafer 10, the dissimilar element layer 3 is not formed in a neighboring region 30 surrounding each of the chip portions (C1, C2), thereby facilitating cutting of the wafer.

In order to verify the effects of the present invention, the following test was conducted to measure the rate of creation of a crack.

A Ti film was formed on the entire surface of an LN substrate (wafer) and then optical waveguide portions and dissimilar element layer portions were formed by photolithography, and the optical waveguides and the dissimilar element layers were thermally diffused into the LN substrate by heating. Thereafter, optical waveguide devices (chips) were cut out, and the ratio of the number of cracks reaching the optical waveguide to the number of cut chips was quantified as a “crack creation rate”.

All optical waveguide substrates were manufactured based on the following numerical values, and the thinned optical waveguide substrate was bonded to a 500 μm thick reinforcing substrate via an adhesive of 30 μm thick.

The thickness t0 of the thin plate is 10 μm (t0=10 μm), the thickness t1 of the dissimilar element layer is 10 μm (t1=10 μm), the width W0 of the chip (rectangular shape) in the short side direction is 2000 μm (W0=2000 μm), and the MFD of the optical waveguide is φ0 μm (MFD=φ0 μm).

In Example 1, the pattern of the region where the dissimilar element layers are formed shown in FIG. 1 was used, and the clearance (a gap) G between the optical waveguide and the dissimilar element layer was set to 30 μm.

In Example 2, the pattern of the region where the dissimilar element layers are formed shown in FIG. 3 was used, and the width of the dissimilar element layer formed along the periphery of the thin plate was set to a width of 100 μm.

In Example 3, the pattern shown in FIG. 4 was used, and the width W1 of the dissimilar element layer was set to a width of 100 μm.

In Example 4, the pattern shown in FIG. 5 was used, the width of the dissimilar element layer along the long side of the thin plate was set to 100 μm, and the clearance between the dissimilar element layers adjacent to each other was set to 50 μm. The angle θ of the cleavage plane of the X-cut thin plate is 60 degrees.

In Comparative Example 1, no dissimilar element layer was formed.

In Comparative Example 2, the pattern shown in FIG. 4 was used, and the width W1 of the dissimilar element layer was set to a width of 20 μm.

Table 1 shows the test results.

TABLE 1

| | | | | | Compar- | Compar- |
|---|---|---|---|---|---|---|
| | Exam- | Exam- | Exam- | Exam- | ative | ative |
| | ple | ple | ple | ple | Exam- | Exam- |
| | 1 | 2 | 3 | 4 | ple 1 | ple 2 |
| Disposi- | FIG. 1 | FIG. 3 | FIG. 4 | FIG. 5 | N/A | FIG. 4 |
| tion of | | | 5% of | | | 1% of |
| Dissimilar | | | Width | | | Width |
| Element | | | | | | |
| Layers | | | | | | |
| Crack | 1% | 2% | 5% | 6% | 11% | 9% |
| Creation | | | | | | |
| Rate | | | | | | |

From the results in Table 1, as shown in Examples 1 to 4, when the dissimilar element layers are formed on the periphery portion of the thin plate, it is possible to reduce the crack creation rate, which is substantially 10% in the related art as shown in Comparative Example 1, to substantially equal to or lower than half. Particularly, in a case where Example 3 and Comparative Example 2 are compared, when the width of the dissimilar element layer is equal to or longer than 5% with respect to the width of the chip in the short side direction, it is confirmed that the creation and progression of a crack are more effectively suppressed.

Furthermore, in the present invention, it is also possible to configure an optical modulation device or an optical transmission apparatus by using the optical waveguide device described above. As shown in FIG. 12, a compact optical modulation device MD can be provided by accommodating the substrate 1 of the optical waveguide device of the present invention in a case SH made of metal or the like and connecting the outside of the case and the optical waveguide device with an optical fiber F. Of course, it is possible not only to optically connect an input part or an output part of the optical waveguide of the substrate 1 and the optical fiber with a space optical system, but also to directly connect the optical fiber to the substrate 1.

By connecting an electronic circuit (a digital signal processor DSP), which outputs a modulation signal So that causes the optical modulation device MD to perform a modulation operation, to the optical modulation device MD, the optical transmission apparatus OTA can be configured. A driver circuit DRV is used because the modulation signal S, which is applied to the optical control element, needs to amplify the output signal So of the DSP. The driver circuit DRV or the digital signal processor DSP can be disposed outside the case SH, but can also be disposed inside the case SH. Particularly, by disposing the driver circuit DRV inside the case, it is possible to further reduce the propagation loss of the modulation signal from the driver circuit.

### INDUSTRIAL APPLICABILITY

As described above, according to the present invention, it is possible to provide an optical waveguide device in which damage to a thin plate, particularly damage to an optical waveguide is prevented.

### REFERENCE SIGNS LIST

1 substrate (thin plate) having electro-optic effect
2 optical waveguide
3 dissimilar element layer
4 adhesive layer
5 reinforcing substrate
MD optical modulation device
OTA optical transmission apparatus
SH case

1. An optical waveguide device comprising:
a thin plate that has an electro-optic effect and that has a thickness of equal to or thinner than 10 μm, an optical waveguide being formed on the thin plate; and
a reinforcing substrate that supports the thin plate, wherein
the thin plate has a rectangular shape in a plan view,
a dissimilar element layer, in which an element different from an element constituting the thin plate is disposed in the thin plate, is formed on at least a portion between an outer periphery of the thin plate and the optical waveguide, and
a total length over which a cleavage plane of the thin plate traverses a region where the dissimilar element layer is formed, is equal to or longer than 5% of a width of the thin plate in a short side direction.

2. The optical waveguide device according to claim 1, wherein
a thickness of the dissimilar element layer is equal to or thicker than half of a thickness of the thin plate.

3. The optical waveguide device according to claim 1, wherein
the dissimilar element layer is formed by diffusing titanium.

4. The optical waveguide device according to claim 3, wherein
the optical waveguide is a diffused waveguide in which a high refractive index material is diffused,
the dissimilar element layer and the optical waveguide are formed on the same surface of the thin plate, and
a thickness from a surface of the thin plate to a highest portion of the dissimilar element layer is set to be thicker than a thickness from the surface of the thin plate to a highest portion of the optical waveguide.

5. The optical waveguide device according to claim 1, wherein
an electrode is formed on the thin plate, and
the electrode and the dissimilar element layer are formed apart from each other.

6. An optical modulation device comprising:
the optical waveguide device according to any one of claims 1 to 5;
a case that accommodates the optical waveguide device; and
an optical fiber that inputs a light wave from an outside of the case to the optical waveguide or that outputs the light wave from the optical waveguide to the outside of the case.

7. The optical modulation device according to claim 6, wherein
an electronic circuit that amplifies a modulation signal, which is input to the optical waveguide device, is provided inside the case.

8. An optical transmission apparatus comprising:
the optical modulation device according to claim 6; and
an electronic circuit that outputs a modulation signal that causes the optical modulation device to perform a modulation operation.
